(19) United States
(12) Patent Application Publication
(10) Pub. No.: US 2011/0233126 A1
(43) Pub. Date: Sep. 29, 2011

(54) Reverse Osmosis Pressure Vessel End Cap Assembly

(76) Inventors: Warren C. Prouty, Danville, NH (US); Mark C. Farrell, Reading, MA (US); David Colby, Medford, MA (US); Abdullatif Zaouk, Jamaica Plain, MA (US); Basant Kumar Parida, Bellingham, MA (US); James Carter, Bedford, MA (US); Norman Dana, Albion, RI (US); Xudong Xin, Quincy, MA (US)

(21) Appl. No.: 12/731,644

(22) Filed: Mar. 25, 2010

(51) Int. Cl. B01D 61/10; B01D 61/02

(52) U.S. Cl. 210/232

(57) ABSTRACT

A reverse osmosis pressure vessel end cap assembly includes a seal plate positioned within a pressure vessel shell, with one or more load plates positioned to retain the seal plate in position. A load ring is captured or expanded by the load plates to secure the load ring into a channel in the interior surface of the pressure vessel shell. The end cap assembly thus provides secure yet easily removable access to the pressure vessel, capable of withstanding the high pressures of a reverse osmosis filtration system. Various exemplary embodiments of the assembly are provided.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND OF THE INVENTION

1. Field of the Invention

The present invention relates generally to pressure vessels, and more particularly to pressure vessels for use in reverse osmosis filtering systems.

2. Description of Related Art

Filtering water to remove impurities is well-known in the art, with various methods and processes known and practiced. For example, simple fiber filtration elements can remove some sediment from water, and activated carbon filtration elements can remove chlorine dissolved in water or other hydrocarbon impurities. Reverse osmosis filtering is a preferred method of desalting or purifying water because it has the capability to remove very small particles and dissolved salts from the water. However, reverse osmosis filtration requires very high pressures in order to force the water being treated through a semi-permeable membrane in order to remove the impurities and dissolved salts. The membranes used for reverse osmosis filtering have physical barrier layer, and are typically designed to allow only water to pass through while preventing the passage of solutes, such as salt ions. Thus, reverse osmosis filtration can be used in the desalination process to purify sea water to drinkable water. Because reverse osmosis filtration requires overcoming the natural osmotic pressure of a fluid being processed, the pressures in reverse osmosis filtration systems are relatively high. For example the natural osmotic pressure for seawater is approximately 800 to 1200 pounds per square inch (p.s.i.). That natural osmotic pressure thus must be overcome in order for the seawater to be forced through a semi-permeable membrane in a reverse osmosis filtration system. Typical reverse osmosis filtration material includes spiral wound membranes.

Reverse osmosis filtering systems typically use a high pressure pump to force the solution being treated, such as water, through the semi-permeable membrane. The membrane allows only the smaller water molecules to pass through, while trapping impurities and dissolved salts. Reverse osmosis filtering can thus remove solids, organics, submicron colloidal material, and even viruses and bacteria from the water.

Because of the high pressures involved, conventional reverse osmosis filtration systems employ pressure vessels made of strong, pressure resistant materials, such as thick PVC, stainless steel, and fiberglass, with the accompanying components of the pressure vessel (seal plates, load plates, ports, etc.) made of similarly strong, pressure resistant materials. While these existing systems are generally effective, the thicknesses of material required to handle the reverse osmosis pressures lead to large, heavy pressure vessels that do not provide the most efficient filtration capability for the footprint and weight of the pressure vessel.

Thus, there remains a need in the art for stronger, lighter weight pressure vessels that provide capability to handle the high pressures of reverse osmosis filtration while also providing increased strength, lighter weight, and providing simpler and more effective features to allow increased filtration capacity and easier maintenance.

### BRIEF SUMMARY OF THE INVENTION

The present invention is directed to reverse osmosis pressure vessels.

In one aspect, exemplary embodiments of the present invention provide a reverse osmosis pressure vessel end cap assembly. The end cap assembly includes a seal plate positioned within a pressure vessel shell, with one or more load plates positioned to retain the seal plate in position. One or more load rings are captured and supported between adjacent load plates with the load ring engaged within a channel in the shell to contain the pressure exerted upon the load plates. The end cap assembly thus provides secure yet easily removable access to the pressure vessel, capable of withstanding the high pressures of a reverse osmosis filtration system.

In another aspect, exemplary embodiments of the present invention provide a reverse osmosis pressure vessel having a tapered side port. The tapered side port fitting is mated within a corresponding aperture in the pressure vessel shell. The angle of the taper disperses forces exerted on the port fitting perpendicularly outwardly to the wall of the process port through the wall of the pressure vessel, permitting a thinner-walled vessel to be employed.

In yet another aspect, exemplary embodiments of the present invention provide a reverse osmosis pressure vessel having a wedge shaped non-metallic load transfer member (referred to herein as “load transfer member”) that bears the thrust load from the load plate. The load transfer member is preferably bonded with a fiber reinforced resin composite (FRRC) material used to form the walls of the pressure vessel, with the slope of the wedge-shaped member providing a smooth transition for wound FRRC material during the manufacture of the pressure vessel.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

The present invention will be described in greater detail in the following detailed description of the invention with reference to the accompanying drawings that form a part hereof, in which:

FIG. 1 is an exploded view of a reverse osmosis pressure vessel end cap assembly in accordance with a first exemplary embodiment of the present invention.

FIG. 2 is a side view of the assembled reverse osmosis pressure vessel end cap assembly of FIG. 1.

FIG. 3 is a perspective view of the assembled reverse osmosis pressure vessel end cap assembly of FIG. 1.

FIG. 4 is an exploded view of a reverse osmosis pressure vessel end cap assembly in accordance with a second exemplary embodiment of the present invention.

FIG. 5 is a side view of the assembled reverse osmosis pressure vessel end cap assembly of FIG. 4.

FIG. 6 is an exploded view of a reverse osmosis pressure vessel end cap assembly in accordance with a third exemplary embodiment of the present invention.

FIG. 7 is a side view of the assembled reverse osmosis pressure vessel end cap assembly of FIG. 6.

FIG. 8 is an exploded view of a reverse osmosis pressure vessel end cap assembly in accordance with a fourth exemplary embodiment of the present invention.

FIG. 9 is a side view of the assembled reverse osmosis pressure vessel end cap assembly of FIG. 8.

FIG. 10 is an exploded view of a reverse osmosis pressure vessel end cap assembly in accordance with a fifth exemplary embodiment of the present invention.

FIG. 11 is a side view of the assembled reverse osmosis pressure vessel end cap assembly of FIG. 10.

FIG. 12 is a side view of a reverse osmosis pressure vessel in accordance with a sixth exemplary embodiment of the present invention.

FIG. 13 is a close-up partial side view of the tapered side port of the reverse osmosis pressure vessel of FIG. 12.

FIG. 14 is a perspective view of the tapered side port fitting of the reverse osmosis pressure vessel of FIG. 12.

FIG. 15 is a side view of a reverse osmosis pressure vessel using a load transfer member in accordance with a seventh exemplary embodiment of the present invention

FIG. 16 is a perspective view of a GRE wedge load transfer member used in the reverse osmosis pressure vessel of FIG. 15.

FIG. 17 is a side view of the GRE wedge load transfer member of FIG. 15.

### DETAILED DESCRIPTION OF EXEMPLARY EMBODIMENTS

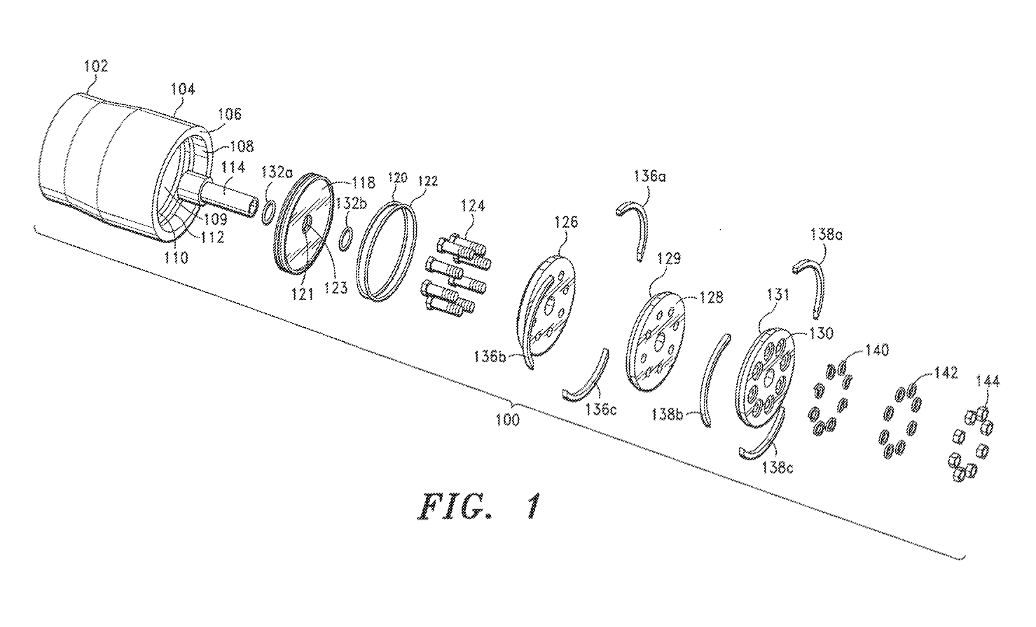

Reverse osmosis pressure vessels in accordance with various exemplary embodiments of the present invention are depicted in FIGS. 1-17. It should be understood that the embodiments described are exemplary and not limiting, and that other alternative embodiments are encompassed by the present invention. It should be further understood that while various features are described in conjunction with the various exemplary embodiments, those features may be combined in other configurations and combinations and need not necessarily be present together as described with respect to the exemplary embodiments.

### First Exemplary Embodiment

Looking first to FIGS. 1-3, a reverse osmosis pressure vessel end cap assembly in accordance with a first exemplary embodiment of the present invention is depicted generally as numeral 100. The end cap assembly includes a generally tubular cylindrical pressure vessel 102, extending between two ends, with an open end located near end portion 104 of the vessel. A wall 106 of the pressure vessel extends between an interior surface 108 and an exterior surface, with interior surface 108 defining an inner cavity 109 within the vessel. First and second channels 110, 112, positioned parallel to each other and near the open end of the vessel, extend circumferentially around the interior surface. Channels 110 and 112 are rectangular in cross-sectional profile to receive a similarly-shaped load ring as will be described in more detail herein below. As depicted in this exemplary embodiment, pressure vessel 102 has at least one open end to allow insertion and removal of a reverse osmosis filter membrane material, such as a spiral wound membrane element, with an end cap assembly as described herein below sealing the filtration elements within the vessel.

Pressure vessel 102 is preferably made from a strong, rigid material capable of withstanding high pressures present in reverse osmosis filtering systems, such as fiber reinforced plastic, fiber reinforced polyester, glass reinforced polyester, or glass reinforced epoxy (GRE). Most preferably, pressure vessel 102 is manufactured by winding resin coated glass/carbon fibers around a mandrel to produce a hard shell pressure vessel. Fiber reinforced resin composites (FRRC) provide greater strength and thus allow a correspondingly thinner wall for a pressure vessel resulting in a lighter, thinner-walled vessel as compared to conventional materials. FRRC is particularly beneficial in use with large scale reverse osmosis filtering systems which employ high pressures and occupy a large area.

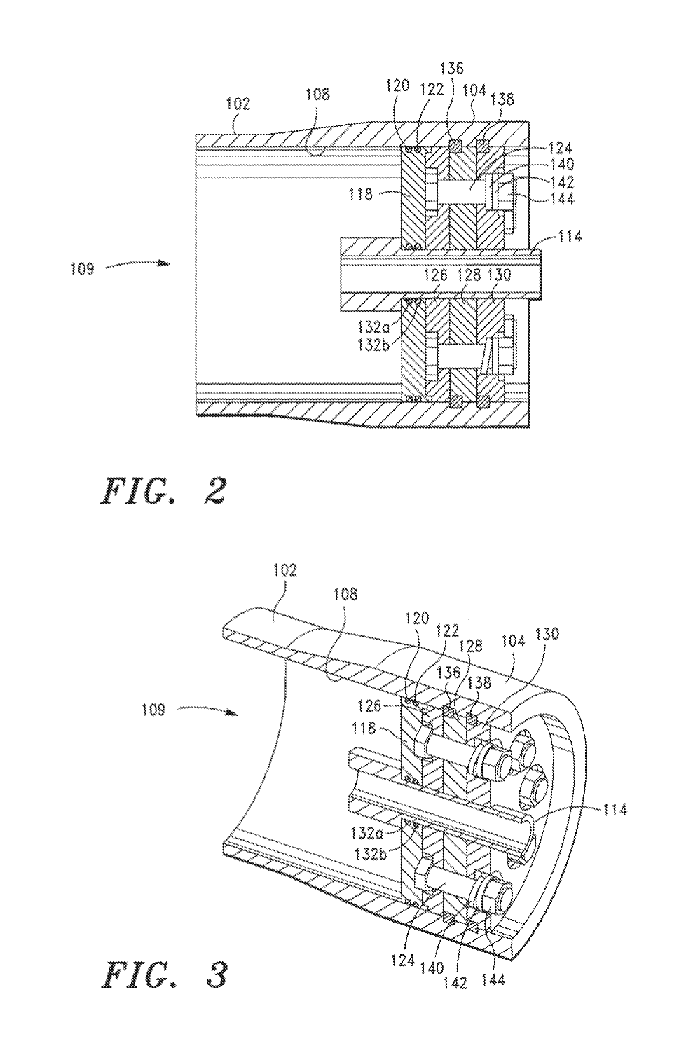

Looking still to FIGS. 1-3, a generally cylindrical seal plate 118 has a perimeter configured to conform generally to the interior surface 108 of the pressure vessel. First and second O-rings 120, 122 are positioned in corresponding grooves extending circumferentially around the perimeter of the seal plate to provide a tight seal between the seal plate and the interior surface of the pressure vessel. As best seen in FIGS. 2 and 3, seal plate 118 is placed in the pressure vessel, positioned interior of the channels near the open end of the vessel. An aperture through the center of the seal plate allows permeate tube 114 to pass through the seal plate, with parallel grooves 121, 123 on the interior perimeter of the seal plate configured to receive center O-rings 132a, 132b to provide a positive seal around the permeate tube. Alternatively, the grooves to receive the O-rings could be on the permeate tube.

First load plate 126, a generally cylindrical plate having eight bolt holes and a center aperture extending there through, is positioned directly adjacent seal plate 118. Second load plate 128, a generally cylindrical plate, also has eight bolt holes and a center aperture extending there through, corresponding to and aligning with the holes in first load plate 126. Second load plate 128 further includes a step on its perimeter to a smaller diameter portion 129 on the interior side of the load plate 128, facing and adjacent to first load plate 126. Third load plate 130 is likewise a generally cylindrical plate having eight bolt holes and a center aperture extending there through, corresponding to and aligning with the holes in the first and second load plates. Third load plate 130 also includes a step on its perimeter to a small diameter portion 131 on the interior side of the load plate 130, facing and adjacent to second load plate 128.

Seal plate 118 is preferably made from a rigid, non-corrosive material such as PVC. First, second and third load plates 126, 128, 130 are preferably made from a rigid material such as metal. Most preferably the load plates are made from a strong, lightweight material such as aluminum or a composite material capable of withstanding high pressures and corrosive environments present in reverse osmosis filtering systems.

Hex bolts 124 extend from the interior side of first load plate 126, and through the bolt holes in all three load plates 126, 128, 130 to corresponding lock washers 140, washers 142, and nuts 144. Thus, hex bolts 124 and associated washers and nuts secure the three load plates together. As can be seen in FIG. 1, third load plate 130 includes recessed areas surrounding each bolt hole on the exterior face of the plate. The recessed area allows the lock washers 140, washers 142 and nuts 144 to protrude minimally beyond the surface of the load plate. As can be seen in FIGS. 2 and 3, first load plate 126 includes similar recesses around the bolt holes on the interior face of the plate so that the heads of hex bolts 124 are recessed flush with, or below, the interior surface of the first load plate 126 so the first load plate can be positioned face to face with seal plate 118 with no interference with the heads of the hex bolts. As can also be seen in FIGS. 2 and 3, permeate tube 114 extends through the center apertures in the load plates to provide a passage for filtered fluid to pass from the pressure vessel.

Finally, segmented load rings 136 (comprising discrete segments 136a, 136b, 136c) and 138 (comprising discrete segments 138a, 138b, 138c) are positioned around the smaller diameter portions 129 and 131 of second and third load plates 128, 130, respectively. Load rings 136, 138 preferably have a generally square cross-sectional profile and conform to the shape of corresponding channels 110 and 112 in the interior surface of the pressure vessel.

As can best be seen in FIGS. 2 and 3, with the components of the reverse osmosis pressure vessel end cap assembly positioned and assembled as described, seal plate 118 is positioned in the interior cavity 109 of pressure vessel 102, interior of the channels 110, 112 near the end of the open end of the vessel. O-rings 120, 122 on the outer perimeter of the seal plate provide a seal between the plate 118 and the interior surface 108 of the pressure vessel. First, second and third load plates 126, 128, and 130 are also positioned in the interior cavity, with first load plate 126 directly adjacent seal plate 118, and second and third load plates 128, 130 positioned initially with their stepped portions adjacent the corresponding channels 110, 112 in the interior surface of the pressure vessel. Load rings 136 and 138 (comprising discrete segments 136a, 136b, 136c and 138a, 138b, 138c, respectively) are positioned in channels 110 and 112, respectively.

With eight hex bolts 124 extending through their respective bolt holes in the seal plate and load plates, tightening lock washers 140, washers 142, and nuts 144 onto the hex bolts draw the load plates together, with the stepped portions 129, 131 of the second and third load plates thus capturing the load rings 136, 138 into the channels 110, 112 in the interior surface of the pressure vessel. With the bolts, lock washers, washers, and nuts fully tightened the load rings 136, 138 are captured and engage into grooves 110, 112 to completely secure the seal plate and load plates within the pressure vessel. Thus, the seal plate is prevented from moving when presented with the high reverse osmosis filtering pressures present in the pressure vessel during operation. As described previously, permeate tube 114 provides an outlet for filtered fluid to exit the pressure vessel after passing through the filtration material in the vessel, with O-rings 132a, 132b providing a seal for the permeate tube.

Other alternative embodiments and configurations are anticipated by the present invention. For example, while eight hex bolts and associated washers and nuts are depicted, other fastener types, or a different number of fasteners may be used. And while the seal plate and load plates are shown with center apertures for a permeate tube, other configurations are within the scope of the present invention. For example, the seal plate and load plates may have no center aperture or permeate tube, with the pressure vessel providing a side port or other fluid port. These and other alternatives are contemplated by the present invention.

### Second Exemplary Embodiment

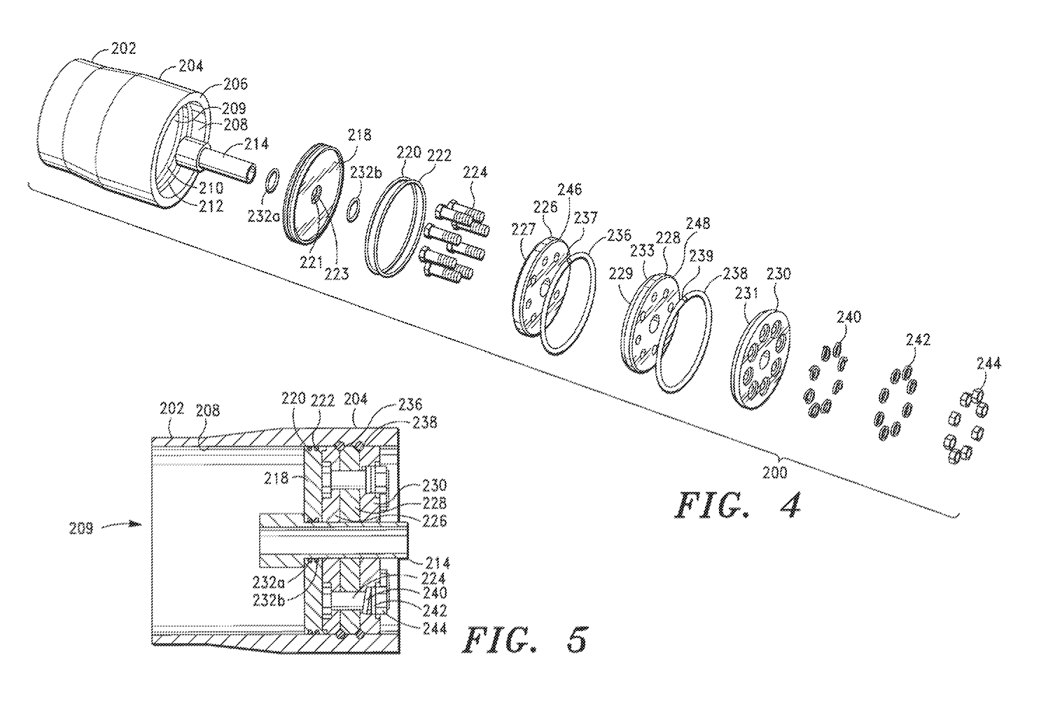

Looking to FIGS. 4 and 5, a reverse osmosis pressure vessel end cap assembly in accordance with a second exemplary embodiment of the present invention is depicted generally as numeral 200. The end cap assembly includes a generally tubular cylindrical pressure vessel 202, extending between two ends, with an open end located near end portion 204 of the vessel. A wall 206 of the pressure vessel extends between an interior surface 208 and an exterior surface, with interior surface 208 defining an inner cavity 209 within the vessel. First and second channels 210, 212, positioned parallel to each other and near the open end of the vessel, extend circumferentially around the interior surface. Channels 210 and 212 are preferably concave and configured to receive a similarly-shaped load ring as will be described in more detail herein below. As depicted in this exemplary embodiment, pressure vessel 202 has at least one open end to allow insertion and removal of a reverse osmosis filter membrane material, such as a spiral wound membrane element, with an end cap assembly as described herein below sealing the filtration material within the vessel.

Pressure vessel 202 is preferably made from a strong, rigid material capable of withstanding high pressures present in reverse osmosis filtering systems, such as fiber reinforced plastic, fiber reinforced polyester, glass reinforced polyester, or glass reinforced epoxy (GRE). Most preferably, pressure vessel 202 is manufactured by winding resin coated glass/carbon fibers around a mandrel to produce a hard shell pressure vessel as described previously.

Looking still to FIGS. 4 and 5, a generally cylindrical seal plate 218 has a perimeter configured to conform generally to the interior surface 208 of the pressure vessel. First and second O-rings 220, 222 are positioned in corresponding grooves extending circumferentially around the perimeter of the seal plate to provide a tight seal between the seal plate and the interior surface of the pressure vessel. As best seen in FIG. 5, seal plate 218 is placed in the pressure vessel, positioned interior of the channels near the open end of the vessel. An aperture through the center of the seal plate allows permeate tube 214 to pass through the seal plate, with parallel grooves 221, 223 on the interior perimeter of the seal plate configured to receive center O-rings 232a, 232b to provide a positive seal around the permeate tube. Alternatively, the grooves to receive the O-rings could be on the permeate tube

First load plate 226, a generally cylindrical plate having eight bolt holes and a center aperture extending there through is positioned directly adjacent seal plate 218. The first load plate further includes a chamfered portion 246 tapering to a smaller diameter on the exterior side of the load plate 226, facing and adjacent to second load plate 228. Second load plate 228, a generally cylindrical plate, also has eight bolt holes and a center aperture extending there through, corresponding to and aligning with the holes in first load plate 226. Second load plate 228 further includes two chamfered portions; 229 tapering to a smaller diameter on the interior side of the load plate 228, facing and adjacent to first load plate 226 and 248 tapering to a smaller diameter on the exterior side of the load plate 228, facing and adjacent to the third load plate 230. Third load plate 230 is likewise a generally cylindrical plate having eight bolt holes and a center aperture extending there through, corresponding to and aligning with the holes in the first and second load plates. Third load plate 230 also includes a chamfered portion 231 tapering to a smaller diameter on the interior side of the load plate 231, facing and adjacent to second load plate 228.

Seal plate 218 is preferably made from a rigid, non-corrosive material such as PVC. First, second and third load plates 226, 228, 230 are preferably made from a rigid material such as metal. Most preferably the load plates are made from a strong, lightweight material such as aluminum or a composite material capable of withstanding high pressures and corrosive environments present in reverse osmosis filtering systems.

Hex bolts 224 extend from the interior side of first load plate 226, and through the bolt holes in all three load plates 226, 228, 230 to corresponding lock washers 240, washers 242, and nuts 244. Thus, hex bolts 224 and associated washers and nuts secure the three load plates together. As can be seen in FIG. 4, third load plate 230 includes recessed areas surrounding each bolt hole on the exterior face of the plate. The recessed area allows the lock washers 240, washers 242 and nuts 244 to protrude minimally beyond the surface of the load plate. As can be seen in FIG. 5, first load plate 226 includes similar recesses around the bolt holes on the interior face of the plate so that the heads of hex bolts 224 are recessed flush with, or below, the interior surface of the first load plate 226 so the first load plate can be positioned face to face with seal plate 218 with no interference with the heads of the hex bolts. As can also be seen in FIG. 5, permeate tube 214 extends through the center apertures in the load plates to provide a passage for filtered fluid to pass from the pressure vessel.

Finally, load rings 236 and 238 are positioned around the chamfered portions 246 and 229 of the first and second load plates and 248 and 231 of the second and third load plates respectively. Load rings 236, 238 preferably have a circular cross-sectional profile and conform to the shape of corresponding channels 210 and 212 in the interior surface of the pressure vessel. Load rings 236, 238 are nearly contiguous, but each includes a gap (237 and 239, respectively) to allow the load ring to expand radially outwardly.

As can best be seen in FIG. 5, with the components of the reverse osmosis pressure vessel end cap assembly positioned and assembled as described, seal plate 218 is positioned in the interior cavity 209 of pressure vessel 202, interior of the channels 210, 212 near the end of the open end of the vessel. O-rings 220, 222 on the outer perimeter of the seal plate provide a seal between the plate 218 and the interior surface 208 of the pressure vessel. First, second and third load plates 226, 228, and 230 are also positioned in the interior cavity, with first load plate 226 directly adjacent seal plate 218, and first and second load plates 226, 228, positioned initially with their chamfered portions adjacent to the corresponding channel 210 and second and third load plates 228, 230 positioned initially with their chamfered portions adjacent the corresponding channel 212 in the interior surface of the pressure vessel. Load rings 236 and 238 are positioned in channels 210 and 212, respectively.

With eight hex bolts 224 extending through their respective bolt holes in the seal plate and load plates, tightening lock washers 240, washers 242, and nuts 244 onto the hex bolts draw the three load plates together, with the chamfered portions of the first and second load plates capturing load ring 236 within channel 210 and the chamfered portions 246, 229, 231 of the second and third load plates capturing load ring 238 within channel 212 in the interior surface of the pressure vessel. With the bolts, lock washers, washers, and nuts fully tightened the load rings 236, 238 are captured and engage with channels 210, 212 to completely secure the seal plate and load plates within the pressure vessel. Thus, the seal plate is prevented from moving when presented with the high reverse osmosis filtering pressures present in the pressure vessel during operation. As described previously, permeate tube 214 provides an outlet for filtered fluid to exit the pressure vessel after passing through the filtration material in the vessel, with O-rings 232a, 232b providing a seal for the permeate tube.

Other alternative embodiments and configurations are anticipated by the present invention. For example, while eight hex bolts and associated washers and nuts are depicted, other fastener types, or a different number of fasteners may be used. And while the seal plate and load plates are shown with center apertures for a permeate tube, other configurations are within the scope of the present invention. For example, the seal plate and load plates may have no center aperture or permeate tube, with the pressure vessel providing a side port or other fluid port. These and other alternatives are contemplated by the present invention.

### Third Exemplary Embodiment

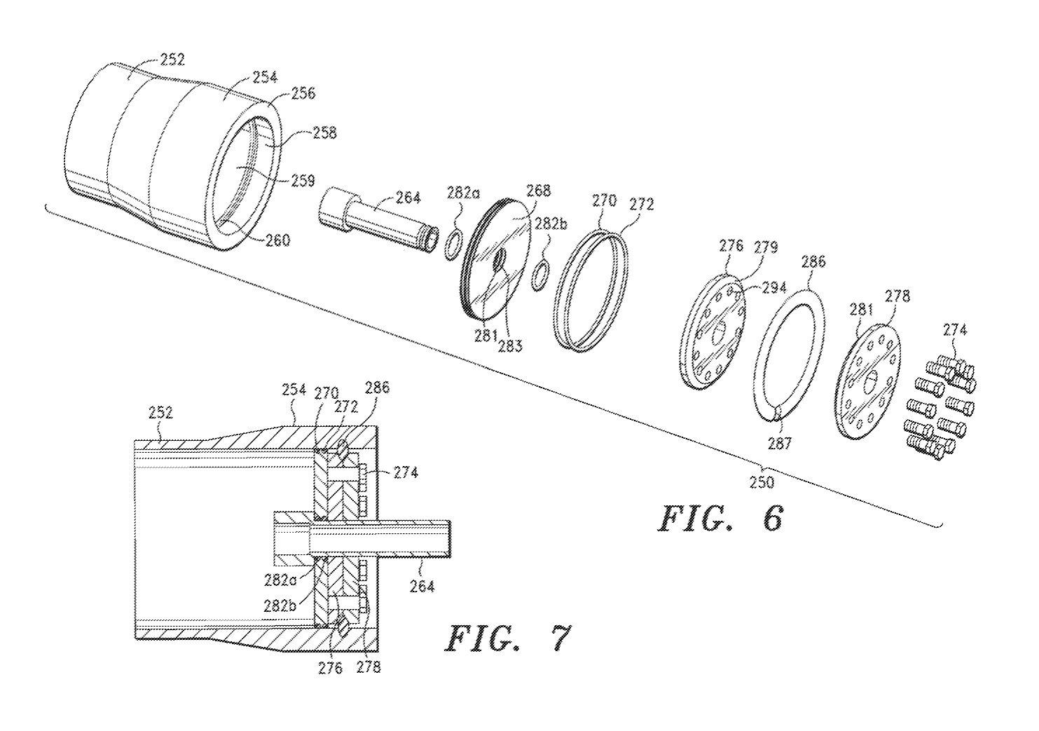

Looking to FIGS. 6 and 7, a reverse osmosis pressure vessel end cap assembly in accordance with a third exemplary embodiment of the present invention is depicted generally as numeral 250. The end cap assembly includes a generally tubular cylindrical pressure vessel 252, extending between two ends, with an open end located near end portion 254 of the vessel. A wall 256 of the pressure vessel extends between an interior surface 258 and an exterior surface, with interior surface 258 defining an inner cavity 259 within the vessel. A channel near the open end of the vessel extends circumferentially around the interior surface. Channel 260 is preferably concave and configured to receive a similarly-shaped load ring as will be described in more detail herein below. As depicted in this exemplary embodiment, pressure vessel 252 has at least one open end to allow insertion and removal of a reverse osmosis filter membrane material, such as a spiral wound membrane element, with an end cap assembly as described herein below sealing the filtration material within the vessel.

Pressure vessel 252 is preferably made from a strong, rigid material capable of withstanding high pressures present in reverse osmosis filtering systems, such as fiber reinforced plastic, fiber reinforced polyester, glass reinforced polyester, or glass reinforced epoxy (GRE). Most preferably, pressure vessel 252 is manufactured by winding resin coated glass/carbon fibers around a mandrel to produce a hard shell pressure vessel as described previously.

Looking still to FIGS. 6 and 7, a generally cylindrical seal plate 268 has a perimeter configured to conform generally to the interior surface 258 of the pressure vessel. First and second O-rings 270, 272 are positioned in corresponding grooves extending circumferentially around the perimeter of the seal plate to provide a tight seal between the seal plate and the interior surface of the pressure vessel. As best seen in FIG. 7, seal plate 268 is placed in the pressure vessel, positioned interior of the channel near the open end of the vessel. An aperture through the center of the seal plate allows permeate tube 264 to pass through the seal plate, with parallel grooves 281, 283 on the interior perimeter of the seal plate configured to receive center O-rings 282a, 282b to provide a positive seal around the permeate tube. Alternatively, the grooves to receive the O-rings could be on the permeate tube

First load plate 276, a generally cylindrical plate having twelve bolt holes and a center aperture extending there through is positioned directly adjacent seal plate 268. First load plate 276 includes a chamfered portion 279 tapering to a smaller diameter and extending circumferentially around the load plate and facing outwardly towards end 254 of the pressure vessel. Second load plate 278, a generally cylindrical plate, also has twelve bolt holes and a center aperture extending there through, corresponding to and aligning with the holes in first load plate 276. Second load plate 278 also includes a chamfered portion 281 tapering to a smaller diameter on the interior side of the load plate 278, facing and adjacent to first load plate 276.

Seal plate 268, and first and second load plates 276, 278 are preferably made from a rigid material such as metal. Most preferably they are made from a strong, lightweight material such as aluminum or a composite material capable of withstanding high pressures and corrosive environments present in reverse osmosis filtering systems.

Hex bolts 274 extend from the exterior side of second load plate 278 through the bolt holes in the second load plate and into corresponding threaded apertures 294 in first load plate 276. Thus, the hex bolts 224 tighten into the threaded apertures to secure the two load plates together. Second load plate 278 may include recessed areas surrounding each bolt hole on the exterior face of the plate to allow the heads of the hex bolts 274 to be recessed below, or protrude minimally from, the surface of the load plate. As can be seen in FIG. 7, permeate tube 264 extends through the center apertures in the load plates to provide a passage for filtered fluid to pass from the pressure vessel.

Load ring 286 is positioned around the chamfered portions 279 and 281 of the first and second load plates. Load ring 286 preferably has a generally elongated cross-sectional profile and fits within corresponding channel 260 in the interior surface of the pressure vessel. Load ring 286 is nearly contiguous, but includes a gap 287 to allow the load ring to expand outwardly radially.

As can best be seen in FIG. 7, with the components of the reverse osmosis pressure vessel end cap assembly positioned and assembled as described, seal plate 268 is positioned in the interior cavity 259 of pressure vessel 252, interior of the channel 260 near the end of the open end of the vessel. O-rings 270, 272 on the outer perimeter of the seal plate provide a seal between the plate 268 and the interior surface 258 of the pressure vessel. First and second 276, 278 are also positioned in the interior cavity, with first load plate 276 directly adjacent seal plate 268, and second load plate 278 positioned initially with their chamfered portions adjacent the channel 260 in the interior surface of the pressure vessel, with load ring 286 positioned in channel 260.

With twelve hex bolts 274 extending through their respective bolt holes in the seal plate and load plates, tightening the bolts into the corresponding threaded apertures 294 draws load plates 276, 278 together, with the chamfered portions 279, 281 thus forcing load ring 286 radially outwardly, into channel 260 in the interior surface of the pressure vessel. With the bolts fully tightened the load ring 286 is captured and engaged with channel 260 and forced outwardly into the channel to completely secure the seal plate and load plates within the pressure vessel. Thus, the seal plate is prevented from moving when presented with the high reverse osmosis filtering pressures present in the pressure vessel during operation. As described previously, permeate tube 264 provides an outlet for filtered fluid to exit the pressure vessel after passing through the filtration material in the vessel, with O-rings 282a, 282b providing a seal for the permeate tube.

Other alternative embodiments and configurations are anticipated by the present invention. For example, while twelve hex bolts and associated washers and nuts are depicted, other fastener types, or a different number of fasteners may be used. And while the seal plate and load plates are shown with center apertures for a permeate tube, other configurations are within the scope of the present invention. For example, the seal plate and load plates may have no center aperture or permeate tube, with the pressure vessel providing a side port or other fluid port. These and other alternatives are contemplated by the present invention

### Fourth Exemplary Embodiment

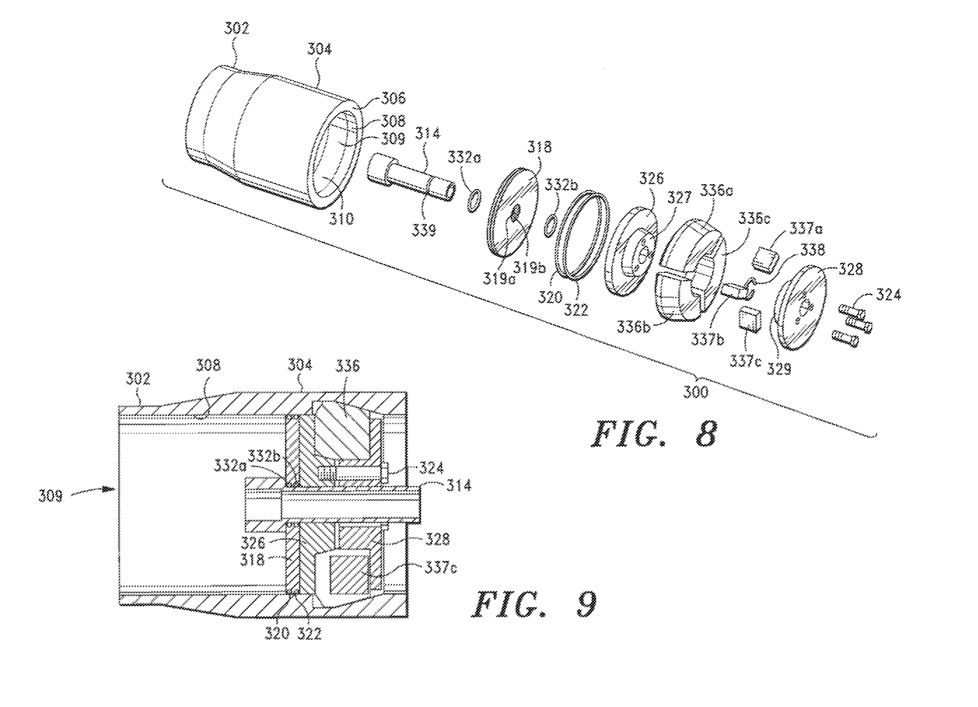

Turning to FIGS. 8 and 9, a reverse osmosis pressure vessel end cap assembly in accordance with a fourth exemplary embodiment of the present invention is depicted generally as numeral 300. The end cap assembly includes a generally tubular cylindrical pressure vessel 302, extending between two ends, with an open end located near end portion 304 of the vessel. A wall 306 of the pressure vessel extends between an interior surface 308 and an exterior surface, with interior surface 308 defining an inner cavity 309 within the vessel. A channel 310 is positioned near the open end of the vessel, extending circumferentially around the interior surface. Channel 310 is preferably wedge shaped and configured to receive similarly-shaped load ring segments as will be described in more detail herein below. As depicted in this exemplary embodiment, pressure vessel 302 has at least one open end to allow insertion and removal of a reverse osmosis filter membrane material, such as a spiral wound membrane element, with an end cap assembly as described herein below sealing the filtration material within the vessel.

Pressure vessel 302 is preferably made from a strong, rigid material capable of withstanding high pressures present in reverse osmosis filtering systems, such as fiber reinforced plastic, fiber reinforced polyester, glass reinforced polyester, or glass reinforced epoxy (GRE). Most preferably, pressure vessel 302 is manufactured by winding resin coated glass/carbon fiber around a mandrel to produce a hard shell pressure vessel as described previously.

Looking still to FIGS. 8 and 9, a generally cylindrical seal plate 318 has a perimeter configured to conform generally to the interior surface 308 of the pressure vessel. First and second O-rings 320, 322 are positioned in corresponding grooves extending circumferentially around the perimeter of the seal plate to provide a tight seal between the seal plate and the interior surface of the pressure vessel. As best seen in FIG. 9, seal plate 318 is placed in the pressure vessel, positioned interior of the channel near the open end of the vessel. An aperture through the center of the seal plate allows permeate tube 314 to pass through the seal plate, with parallel grooves 319a, 319b on the interior perimeter of the seal plate configured to receive center O-rings 332a, 332b to provide a positive seal around the permeate tube. Alternatively, the grooves to receive the O-rings could be on the permeate tube.

First load plate 326, a generally cylindrical plate having a center aperture extending there through is positioned directly adjacent seal plate 318. First load plate 326 includes a protruding, chamfered boss 327 on the face opposite the seal plate, the boss extending outwardly towards the open end of the pressure vessel. Boss 327 includes three threaded apertures on its face, each aperture configured to receive a mating fastener. Snap ring 338 is installed in groove 339 on permeate tube 314 after assembly with seal plate and first load plate. Snap ring 338 keeps the seal plate and load plate positioned square on the permeate tube for assembly. Second load plate 328, a generally cylindrical plate, also includes a center aperture extending there through, corresponding to and aligning with the center aperture in first load plate 326. Second load plate 328 further includes a protruding, chamfered boss 329 on the face facing the seal plate, the boss extending inwardly towards the interior of the pressure vessel.

Seal plate 318 is preferably made from a rigid, non-corrosive material such as PVC. First and second load plates 326, 328 are preferably made from a rigid material such as metal. Most preferably the load plates are made from a strong, lightweight material such as aluminum or a composite material capable of withstanding high pressures and corrosive environments present in reverse osmosis filtering systems.

Three fastener bolts 324 extend from the exterior face of second load plate 328, through corresponding bolt holes in the second load plate, and to the threaded apertures in the chamfered boss 327 of first load plate 326. Thus, bolts 324 secure the two load plates together. As can be seen in FIG. 9, permeate tube 314 extends through the center apertures in the load plates to provide a passage for filtered fluid to pass from the pressure vessel.

Finally, load ring segments 336a, 336b, 336c are positioned around the facing chamfered bosses 327, 329 of first and second load plates 326, 328 respectively, with spacers 337a, 337b, 337c positioned between the adjacent segments. Load ring segments 336a, 336b, 336c are preferably substantially identical and have a tapered or wedge-shaped profile to conform to the shape of corresponding channel 310 in the interior surface of the pressure vessel.

As can best be seen in FIG. 9, with the components of the reverse osmosis pressure vessel end cap assembly positioned and assembled as described, seal plate 318 is positioned in the interior cavity 309 of pressure vessel 302, interior of the channel 310 near the open end of the vessel. O-rings 320, 322 on the outer perimeter of the seal plate provide a seal between the plate 318 and the interior surface 308 of the pressure vessel. First and second load plates 326, 328 are also positioned in the interior cavity, with first load plate 326 directly adjacent seal plate 318 with its chamfered boss portion 327 facing outwardly, away from the seal plate, and second load plate 328 positioned with its chamfered boss portion 329 facing inwardly towards the first load plate. Load ring segments 336a, 336b, 336c and spacers 337a, 337b, 337c are positioned around the chamfered bosses, in channel 310.

With the three fastener bolts 324 extending through the respective bolt holes in second load plate 328 and into the threaded apertures of chamfered boss 327, tightening the bolts draws the two load plates together, with the chamfered boss portions 327, 329 of the load plates thus forcing the load ring segments 336a, 336b, 336c and spacers 337a, 337b, 337c radially outwardly, into channel 310 in the interior surface of the pressure vessel. With the fastener bolts 324 fully tightened the load ring segments are expanded fully outwardly to completely secure the seal plate and load plates within the pressure vessel. Thus, the seal plate is prevented from moving when presented with the high reverse osmosis filtering pressures present in the pressure vessel during operation. As described previously, permeate tube 314 provides an outlet for filtered fluid to exit the pressure vessel after passing through the filtration material in the vessel, with O-rings 332a, 332b providing a seal for the permeate tube.

Other alternative embodiments and configurations are anticipated by the present invention. For example, while three fastener bolts and threaded apertures are depicted, other fastener types, or a different number of fasteners may be used. And while the seal plate and load plates are shown with center apertures for a permeate tube, other configurations are within the scope of the present invention. For example, the seal plate and load plates may have no center aperture or permeate tube, with the pressure vessel providing a side port or other fluid port. These and other alternatives are contemplated by the present invention.

### Fifth Exemplary Embodiment

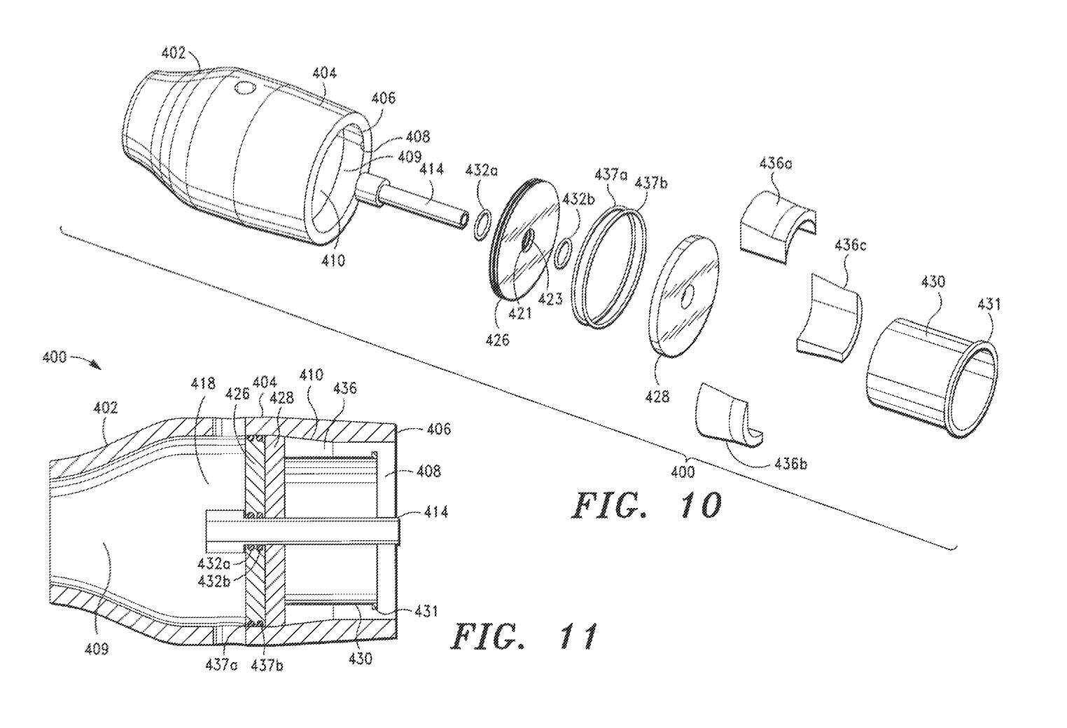

Looking to FIGS. 10 and 11, a reverse osmosis pressure vessel end cap assembly in accordance with a fifth exemplary embodiment of the present invention is depicted generally as numeral 400. The end cap assembly includes a generally tubular cylindrical pressure vessel 402, extending between two ends, with an open end located near end portion 404 of the vessel. A wall 406 of the pressure vessel extends between an interior surface 408 and an exterior surface, with interior surface 408 defining an inner cavity 409 within the vessel. As seen in FIG. 11, a tapered channel 410 extends circumferentially around the interior surface, near the open end of the pressure vessel. As depicted in this exemplary embodiment, pressure vessel 402 has at least one open end to allow insertion and removal of a reverse osmosis filter membrane material, such as a spiral wound membrane element, with an end cap assembly as described herein below sealing the filtration material within the vessel.

Pressure vessel 402 is preferably made from a strong, rigid material capable of withstanding high pressures present in reverse osmosis filtering systems, such as fiber reinforced plastic, fiber reinforced polyester, glass reinforced polyester, or glass reinforced epoxy (GRE). Most preferably, pressure vessel 402 is manufactured by winding resin coated glass/carbon fiber around a mandrel to produce a hard shell pressure vessel as described previously.

Looking still to FIGS. 10 and 11, a generally cylindrical seal plate 426 comprises a perimeter configured to conform generally to the interior surface 408 of the pressure vessel. First and second o-rings 437a, 437b are positioned in corresponding grooves extending circumferentially around the perimeter of the seal plate to provide a tight seal between the seal plate and the interior surface of the pressure vessel. Load plate 428, a generally cylindrical plate having a center aperture extending there through, is positioned adjacent to seal plate 426. Load plate 428 is preferably made from a rigid material such as metal. Most preferably it is made from a strong, lightweight material such as aluminum or a composite material capable of withstanding high pressures present in reverse osmosis filtering systems. As can be seen in FIG. 11, permeate tube 414 extends through the center apertures in the seal plate and load plate to provide a passage for filtered fluid to pass from the pressure vessel.

Load ring segments 436a, 436b, 436c are positioned around the perimeter of the interior cavity 409, around sleeve 430. Sleeve 430 is a generally cylindrical tube, with a lip 431 extending radially outward from the exterior end of the sleeve. Load ring segments 436a, 436b, 436c are preferably similar but are sectioned for installation and removal without the need for spacers. Each load ring segment has a generally wedge-shaped profile to conform to the shape of corresponding channel 410 in the interior surface of the pressure vessel.

As can best be seen in FIG. 11, with the components of the reverse osmosis pressure vessel end cap assembly positioned and assembled as described, the load plate 428 is positioned in the interior cavity directly adjacent to, and outside of, seal plate 426. Load ring segments 436a, 436b, 436c are positioned around sleeve 430, adjacent the interior surface 409 of the vessel.

With the load ring segments 436a, 436b, 436c positioned loosely in recess 410, pressing sleeve 430 inwardly towards the interior of the pressure vessel positions the load ring segments radially into channel 410 in the interior surface of the pressure vessel. Thus, the collar and load plates are prevented from moving when presented with the high reverse osmosis filtering pressures present in the pressure vessel during operation. As described previously, permeate tube 414 provides an outlet for filtered fluid to exit the pressure vessel after passing through the filtration material in the vessel, with O-rings 432a, 432b positioned in interior grooves 421, 423 of the seal plate 426 to provide a seal for the permeate tube. Lip 431 on the exterior end of sleeve 430 provides a grip surface to remove the sleeve thereby releasing the load ring segments for removal as necessary.

Other alternative embodiments and configurations are anticipated by the present invention. For example, the seal plate and load plate may have no center aperture or permeate tube, with the pressure vessel providing a side port or other fluid port. Or, the load rings could comprise one or more spacers to position the segments, such as when the load ring is segmented radially. These and other alternatives are contemplated by the present invention.

### Sixth Exemplary Embodiment

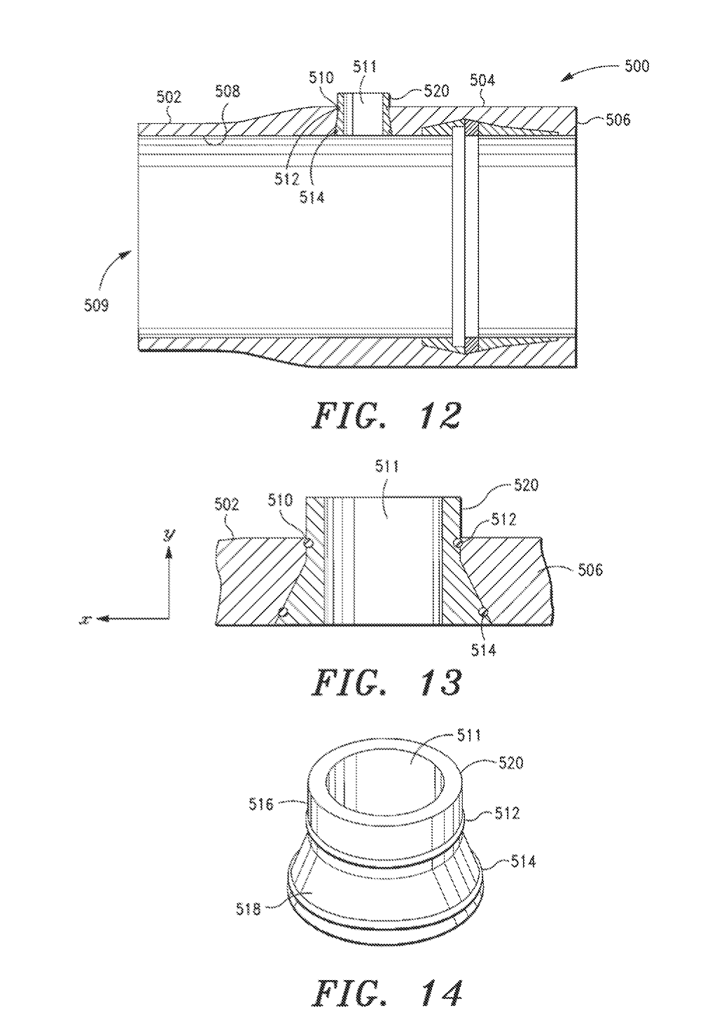

Looking to FIGS. 12-14, a reverse osmosis pressure vessel in accordance with a sixth exemplary embodiment of the present invention is depicted generally as numeral 500. The pressure vessel includes a generally tubular, generally cylindrical shell 502, extending between two ends. A wall 506 of the shell between an interior surface 508 and an exterior surface, with interior surface 508 defining an inner cavity 509 within the vessel. As shown in FIG. 12, an end of the shell 502 may be capped with a seal plate near end portion 504 of the shell in a manner similar to that described above with respect to exemplary embodiments one through four.

As depicted in this exemplary embodiment, shell 502 has at least one open end to allow insertion and removal of a reverse osmosis filter membrane material, such as a spiral wound membrane element, with an end cap assembly as described previously sealing the filtration material within the vessel.

Shell 502 is preferably made from a strong, rigid material capable of withstanding high pressures present in reverse osmosis filtering systems, such as fiber reinforced plastic, fiber reinforced polyester, glass reinforced polyester, or glass reinforced epoxy (GRE). Most preferably, pressure vessel 502 is manufactured by winding resin coated glass/carbon fiber around a mandrel to produce a hard shell pressure vessel as described previously.

An aperture 510 extends through wall 506 of shell 502, the aperture having a smaller diameter at the outer surface of the shell and a larger diameter at the inner surface of the shell so that the aperture is generally tapered from larger to smaller as it extends from the interior surface of the pressure vessel to the exterior through wall 506. As best seen in FIG. 13, aperture 510 has a first portion adjacent the outer surface of the shell which has generally parallel walls, and a second portion adjacent the interior surface of the shell that has walls that taper from a larger diameter at the interior surface to a smaller diameter at the junction with the first portion parallel walls.

Port fitting 520 is shaped similarly to aperture 510, having a smaller diameter upper portion 516 with substantially parallel walls, and a larger diameter lower portion 518 that tapers from a larger diameter at the lower end of the fitting to a smaller diameter at the junction with the upper portion 518. Thus, port fitting 520 is configured to conform to the shape of the aperture 510 formed in the wall 506 of the shell 502. Preferably the walls of lower portion 518 taper at a slope of approximately ten degrees from the axis of the fitting, as do the tapered walls of aperture 510. Port fitting 520 further includes first and second O-rings 512, 514 positioned circumferentially around the fitting to provide a seal between the fitting and wall 506. First O-ring 512 is preferably positioned around the upper portion 516 of the fitting, near the junction of upper and lower portions 516, 518 of the fitting, with the second O-ring 514 positioned on the lower tapered portion 518 of the fitting, near the bottom of the fitting. As best seen in FIG. 13, port fitting 520 thus fits securely into aperture 510, with the O-rings providing a seal between the fitting and the wall of the shell. A retainer on the exterior of the shell secures the port fitting within the aperture.

Looking to FIG. 13, it will be apparent that any force exerted against port fitting 520 will be dispersed both longitudinally (i.e., in the x direction shown) and laterally (i.e., in the y direction shown) so that the force is dispersed optimally, balancing hoop and axial loads to take maximum advantage of the inherent properties of the composite material. By contrast, a conventional side port fitting having generally parallel walls and a lip or boss on the interior end exerts almost all of its force laterally against the wall (i.e., in the y direction). Thus, the tapered side port fitting of the present invention and as depicted in this fifth exemplary embodiment disperses the force which allows using a thinner wall for a given pressure vessel application. Thinner walled pressure vessels are lighter weight, cost less to produce, and have greater capacity compared to similarly sized vessels having thicker walls.

Alternative embodiments and configurations are anticipated by the present invention. For example, the port fitting 520 may have longer or shorter upper and lower portions, with correspondingly different angles of taper on the walls of the lower portion. These and other alternatives are contemplated by the present invention.

### Seventh Exemplary Embodiment

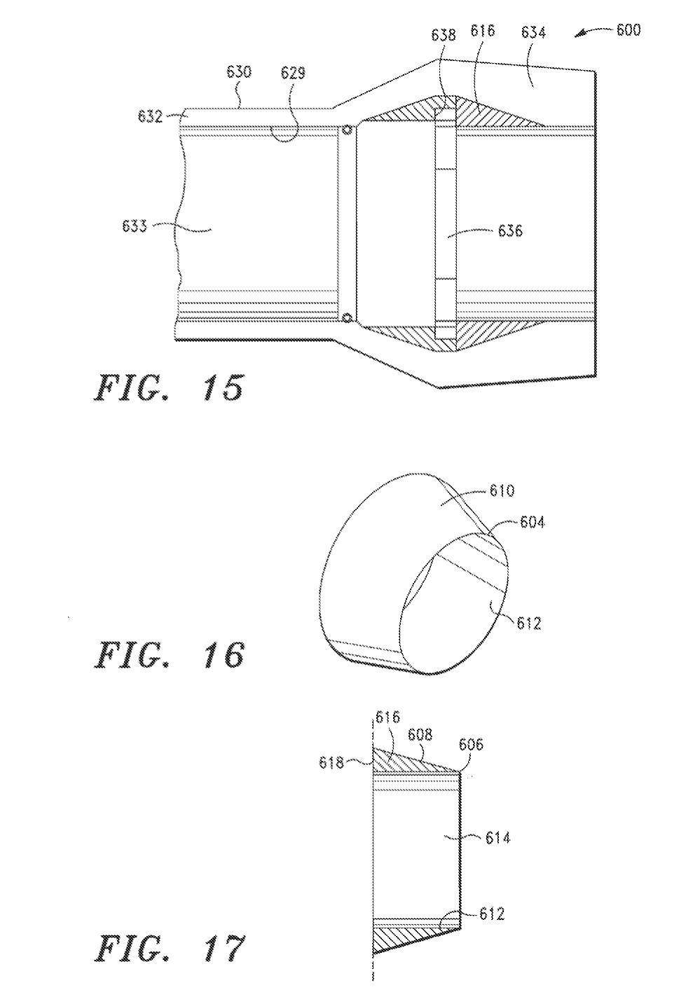

Looking to FIGS. 15-17, a reverse osmosis pressure vessel in accordance with a seventh exemplary embodiment of the present invention is depicted generally as numeral 600. Pressure vessel 600 comprises a generally tubular cylindrical pressure vessel shell 630, extending between two open ends. A wall 632 of the pressure vessel shell extends between an interior surface 629 and an exterior surface, with interior surface 629 defining an inner cavity 633 within the shell. A non-metallic load transfer member having a generally wedge-shaped cross-sectional profile is positioned near one end of the pressure vessel shell 630 so that the exterior diameter of the shell is greater where the wall of the shell 634 covers the load transfer member. Load transfer member 616 presents a sloped outer surface of the GRE member engaging with the wall 634 of the pressure vessel shell. The sloped outer surface provides a continuous, smooth surface for winding the vessel shell material and disperses loads optimally, balancing hoop and axial loads to take maximum advantage of the inherent properties of the composite material.

Preferably, the outer surface of the load transfer member is adhered to the wall of the pressure vessel shell. Most preferably, the outer wall of the pressure vessel shell is also made of FRRC so that the FRRC wall and load transfer member are bonded to form a unitary piece.

Looking to FIGS. 16 and 17, wedge-shaped load transfer member 616 can be made so that an interior passageway 614 extends from first and second ends 604, 606, the interior passageway defined by interior surface 612. Sloped surface 608 tapers from a narrower diameter at the open end of the shell to a larger diameter at the interior of the shell. Preferably, surface 608 slopes at approximately sixteen degrees.

Most preferably, pressure vessel 600 is formed by placing a load transfer wedge-shaped member 616 on a forming mandrel. FRRC material is then wrapped around the mandrel and load transfer member so that the FRRC material bonds with the wedge-shaped load transfer member to form a bond between the two. The approximately sixteen degree slope of the outer surface of the load transfer member provides a gentle transition for the wound FRRC material so that the material smoothly transitions from the narrower diameter portion of the shell to the greater diameter portion of the shell over the load transfer member. When the formed pressure vessel is removed from the forming mandrel, the load transfer member provides a surface 618 to receive the thrust load due to the high reverse osmosis filtering pressure present in the pressure vessel during operation.

Other alternative embodiments and configurations are anticipated by the present invention. The wedge-shaped member may be manufactured of materials other than FRRC. These and other alternatives are contemplated by the present invention.

It should be apparent to one skilled in the art that the reverse osmosis pressure vessels of the present invention described and illustrated hereinabove with respect to various exemplary embodiments provide several advantages over existing pressure vessel designs. For example, the various end cap assemblies provide simple and effective sealing of reverse osmosis pressure vessels employing high pressures. The tapered side port disperses forces more optimally through the walls of the pressure vessel, allowing thinner walled vessels to be used effectively. And, the wedge-shaped load transfer member provides a load transfer mechanism for lower pressure applications such as brackish water, eliminating the need for costly embedded metallic rings.

While the present invention has been described and illustrated hereinabove with reference to various exemplary embodiments, it should be understood that various modifications could be made to these embodiments without departing from the scope of the invention. Furthermore, the combinations of features depicted in the exemplary embodiments are not limited to those described and shown, the various features of the various combinations may be configured or arranged in combinations other than those shown and described in the exemplary embodiments. Therefore, the invention is not to be limited to the exemplary embodiments described and illustrated hereinabove.

What is claimed and desired to be secured by Letters Patent is as follows:

1. A reverse osmosis pressure vessel end cap assembly, comprising:
a generally tubular pressure vessel having at least one open end, said pressure vessel having an interior surface defining an interior cavity, an exterior surface, and a wall extending therebetween;
a generally cylindrical seal plate positioned within said pressure vessel, a perimeter of said seal plate configured to conform closely to said interior surface;
a generally cylindrical first load plate positioned adjacent said seal plate;
a generally cylindrical second load plate positioned adjacent said first load plate; and
a first load ring positioned between said first and second load plates such that said load ring is captured between said load plates when said second load plate is secured against said first load plate to retain said seal plate and said load plates in position within said pressure vessel.

2. The assembly of claim 1, wherein said seal plate comprises a groove extending circumferentially around said seal plate adjacent to said inner surface of said pressure vessel and an O-ring positioned in said groove to provide a seal between said seal plate and said pressure vessel.

3. The assembly of claim 1, further comprising fasteners extending between said first and second load plates, said fasteners configured to secure said load plates together.

4. The assembly of claim 1, wherein said pressure vessel comprises FRRC.

5. The assembly of claim 1, wherein said pressure vessel comprises at least one channel extending circumferentially around said interior surface, said channel configured to receive said first load ring.

6. The assembly of claim 5, wherein said first load ring comprises a plurality of discrete segments.

7. The assembly of claim 6, wherein each of said discrete segments extends around approximately one-hundred and twenty degrees of a circumference of said channel.

8. The assembly of claim 6, wherein said discrete segments have a generally square cross-sectional profile.

9. The assembly of claim 8, wherein a cross-sectional profile of said channel is approximately square.

10. The assembly of claim 5, wherein said first load ring comprises a unitary part.

11. The assembly of claim 10, wherein said first load ring comprises a gap allowing said load ring to expand circumferentially.

12. The assembly of claim 11, wherein at least one of said load plates comprises a chamfered portion positioned adjacent to said first load ring such that tightening said load plates together expands said load ring outwardly to engage with said pressure vessel.

13. The assembly of claim 12, wherein said pressure vessel comprises at least one channel extending circumferentially around said interior surface, said channel configured to receive said radially expanded load ring.

14. The assembly of claim 1, further comprising
a generally cylindrical third load plate positioned adjacent said second load plate, and
a second load ring positioned between said second and third load plates such that said second load ring is captured between said second and third load plates when said third load plate is secured against said second load plate to retain said seal plate and said load plates in position within said pressure vessel.

15. The assembly of claim 14, further comprising fasteners extending between said first, second, and third load plates, said fasteners configured to secure said load plates together.

16. The assembly of claim 14, wherein said pressure vessel comprises at least two channels extending circumferentially around said interior surface, said channels configured to receive said first and second load rings, respectively.

17. The assembly of claim 16, wherein said first and second load rings each comprise a plurality of discrete segments.

18. The assembly of claim 17, wherein each of said discrete segments extends around approximately one-hundred and twenty degrees of a circumference of said channel.

19. The assembly of claim 18, wherein said discrete segments have a generally square cross-sectional profile.

20. The assembly of claim 19, wherein a cross-sectional profile of each of said first and second channels is approximately square.

21. The assembly of claim 16, wherein each of said first and second load ring segments together comprise a unitary part.

22. The assembly of claim 21, wherein each of said first and second load rings comprises a gap allowing said load rings to expand radially.

23. The assembly of claim 22, wherein at least one of said load plates comprises a chamfered portion positioned adjacent at least one of said load rings such that tightening said load plates together expands said load ring outwardly to engage with said pressure vessel.

24. The assembly of claim 23, wherein said pressure vessel comprises at least one channel extending circumferentially around said interior surface, said channel configured to receive said radially expanded load ring.

25. The assembly of claim 24, wherein said channel is generally concave.

26. A reverse osmosis pressure vessel end cap assembly, comprising:
a generally tubular pressure vessel having at least one open end, said pressure vessel having an interior surface defining an interior cavity, an exterior surface, and a wall extending therebetween;
a generally cylindrical seal plate positioned within said pressure vessel, a perimeter of said seal plate configured to conform closely to said interior surface;
a plurality of generally cylindrical load plates positioned in said interior cavity adjacent said seal plate, at least one of said load plates having a stepped portion extending circumferentially around a first side of said load plate and facing an adjacent load plate; and
at least one load ring positioned around said stepped portion such that said stepped portion captures said load ring in engagement with said interior surface of said pressure vessel when said load plates are secured together.

27. The assembly of claim 26, wherein said pressure vessel comprises FRRC.

28. The assembly of claim 26, wherein said seal plate comprises at least one groove extending circumferentially around said seal plate adjacent said inner surface of said pressure vessel and at least one O-ring positioned in said groove to provide a seal between said seal plate and said pressure vessel.

29. The assembly of claim 26, further comprising at least one fastener extending between said load plates, said fasteners configured to secure said load plates together.

30. The assembly of claim 26, wherein said pressure vessel comprises at least one channel extending circumferentially around said interior surface, said channel configured to receive said at least one load ring.

31. The assembly of claim 30, wherein said load ring comprises a plurality of discrete segments.

32. The assembly of claim 31, wherein each of said discrete segments extends around approximately one-hundred and twenty degrees of a circumference of said channel.

33. The assembly of claim 32, wherein said discrete segments have a generally square cross-sectional profile.

34. The assembly of claim 33, wherein a cross-sectional profile of said channel is approximately square.

35. The assembly of claim 32, wherein said load ring segments together comprise a unitary part.

36. The assembly of claim 35, wherein said load ring comprises a gap allowing said load ring to expand radially.

37. The assembly of claim 36, wherein at least one of said load plates comprises a chamfered portion positioned adjacent said load ring such that tightening said load plates together expands said load ring outwardly to engage with said pressure vessel.

38. The assembly of claim 37, wherein said pressure vessel comprises at least one channel extending circumferentially around said interior surface, said channel configured to receive said radially expanded load ring.

39. A reverse osmosis pressure vessel end cap assembly, comprising:
a generally tubular pressure vessel having at least one open end, said pressure vessel having an interior surface defining an interior cavity, an exterior surface, and a wall extending therebetween, said interior surface comprising at least one channel extending circumferentially around said interior surface;
a generally cylindrical seal plate positioned within said pressure vessel, said seal plate comprising at least one groove extending circumferentially around said seal plate adjacent said inner surface of said pressure vessel, and at least one O-ring positioned in said groove to provide a seal between said seal plate and said interior surface;
a plurality of generally cylindrical load plates positioned in said interior cavity adjacent said seal plate; and
at least one load ring positioned between said load plates such that said load ring is captured between said load plates when they are secured together.

40. The assembly of claim 39, wherein said pressure vessel comprises FRRC.

41. The assembly of claim 39, further comprising a plurality of fasteners extending between said load plates, said fasteners configured to secure said load plates together.

42. The assembly of claim 39, wherein said load ring comprises a plurality of discrete segments.

43. The assembly of claim 42, wherein each of said discrete segments extends around approximately one-hundred and twenty degrees of a circumference of said channel.

44. The assembly of claim 43, wherein said load ring segments together comprise a unitary part.

45. The assembly of claim 44, wherein said load ring comprises a gap allowing said load ring to expand radially.

46. The assembly of claim 45, wherein at least one of said load plates comprises a chamfered portion positioned adjacent at least one of said load rings such that tightening said load plates together expands said load ring outwardly to engage with said pressure vessel.

47. The assembly of claim 46, wherein pressure vessel comprises at least one channel extending circumferentially around said interior surface, said channel configured to receive said radially expanded load ring.

48. A reverse osmosis pressure vessel end cap assembly, comprising:
a generally tubular pressure vessel having at least one open end, said pressure vessel having an interior surface defining an interior cavity, an exterior surface, and a wall extending therebetween, said interior surface comprising at least one channel extending circumferentially around said interior surface;
a generally cylindrical seal plate positioned within said pressure vessel, said seal plate comprising at least one groove extending circumferentially around said seal plate adjacent said inner surface of said pressure vessel, and at least one O-ring positioned in said groove to provide a seal between said seal plate and said interior surface;
a first generally cylindrical load plate positioned in said interior cavity adjacent said seal plate and having a chamfered boss extending outwardly therefrom;
a second generally cylindrical load plate positioned adjacent said first load plate and having a chamfered boss extending inwardly therefrom, towards said first load plate;
a load ring comprised of a plurality of segments positioned around said adjacent chamfered bosses such that said chamfered bosses expand said load ring radially outwardly into said channel when said load plates are secured together.

49. The assembly of claim 48, wherein said pressure vessel comprises FRRC.

50. The assembly of claim 48, further comprising a plurality of fasteners extending between said load plates, said fasteners configured to draw and secure said load plates together.

51. The assembly of claim 48, further comprising a plurality of spacers positioned between said load plates and positioned between adjacent segments of said load ring to fill gaps in said load ring when said load ring is expanded radially.

52. The assembly of claim 48, wherein said plurality of segments comprises three substantially identical discrete segments, and wherein said plurality of spacers comprises three substantially identical spacers.

53. A reverse osmosis pressure vessel end cap assembly, comprising:
a generally tubular pressure vessel having at least one open end, said pressure vessel having an interior surface defining an interior cavity, an exterior surface, and a wall extending therebetween, said interior surface comprising at least one recessed area extending circumferentially around said interior surface;
a generally cylindrical seal plate positioned within said inner cavity, said seal plate configured to conform closely to said interior surface;
a first generally cylindrical load plate positioned in said interior cavity adjacent to said seal plate;
a load ring comprised of a plurality of segments positioned adjacent to said load plate; and
a generally tubular sleeve positioned within said load ring such that said sleeve secures said segments of said load ring into said channel to secure said load plate in said pressure vessel.

54. The assembly of claim 53, wherein said pressure vessel comprises FRRC.

55. The assembly of claim 53, further comprising a second generally cylindrical load plate positioned adjacent to said first load plate.

56. The assembly of claim 53, wherein said sleeve comprises a lip projecting outwardly around a circumference of an end of said collar.

57. The assembly of claim 53, wherein said plurality of segments comprises three substantially identical discrete segments.

58. The assembly of claim 53, wherein said seal plate comprises at least one groove extending circumferentially around said seal plate adjacent said inner surface of said pressure vessel and at least one O-ring positioned in said groove to provide a seal between said seal plate and said pressure vessel.
